(19) United States
(12) Patent Application Publication
(10) Pub. No.: US 2023/0095071 A1
(43) Pub. Date: Mar. 30, 2023

(54) CLOUD-BASED IDENTIFICATION AND DIGITIZATION SYSTEM AND METHOD FOR ADVANCED BATTERIES

(71) Applicant: SpinorX Inc., Toronto (CA)

(72) Inventor: Shahab Shokrzadeh, Aurora (CA)

(21) Appl. No.: 17/953,999

(22) Filed: Sep. 27, 2022

Related U.S. Application Data
(60) Provisional application No. 63/261,723, filed on Sep. 27, 2021.

(51) Int. Cl. H04L 41/0803; H02J 7/00; H04L 67/12

(52) U.S. Cl. CPC H04L 41/0803; H02J 7/00032; H04L 67/12

(57) ABSTRACT

The present invention relates to systems and methods for identifying, with an onboard Battery Identity Module (BIM), an advanced rechargeable battery sub-pack that is module or cell for the purpose of collecting data and information about the full battery life cycle including the origin of materials to manufacturing, service life, second life, and recycling. The granular data collected down to the cell level over the battery life cycle is collectively named as Battery Life Intelligence (BLI) and recorded under the BIM in an immutable cloud-based data lake.

### INCORPORATION BY REFERENCE

This application is a non-provisional application which claims priority from US Provisional Patent Application No. 63/261,723 entitled “CLOUD-BASED IDENTIFICATION AND DIGITIZATION SYSTEM AND METHOD FOR ADVANCED BATTERIES”, filed on 27 Sep. 2021, the entirety of which is hereby incorporated by reference.

### TECHNICAL FIELD OF THE INVENTION

The present invention relates to systems and methods for identifying, with an onboard

Battery Identity Module (BIM), an advanced rechargeable battery sub-pack that is module or cell for the purpose of collecting data and information about the full battery life cycle including the origin of materials to manufacturing, service life, second life, and recycling. The granular data collected down to the cell level over the battery life cycle is collectively named as Battery Life Intelligence (BLI) and recorded under the BIM in an immutable cloud-based data lake.

### BACKGROUND

Batteries perform the function of providing stored energy to an underlying electrical or electronic system. N Nitta, Naoki, et al. “Li-ion battery materials: present and future.” Materials today 18.5 (2015): 252-264, discloses key technological developments and scientific challenges for a broad range of Li-ion battery electrodes, and discusses performance characteristics, current limitations, and recent breakthroughs in the development of commercial intercalation materials such as lithium cobalt oxide (LCO), lithium nickel cobalt manganese oxide (NCM), lithium nickel cobalt aluminum oxide (NCA), lithium iron phosphate (LFP), lithium titanium oxide (LTO). The cost, abundance, safety, Li and electron transport, volumetric expansion, material dissolution, and surface reactions for each type of electrode materials are disclosed as well. Both general and specific strategies to overcome the current challenges are covered and categorized.

Mathiesen, Brian Vad, et al. “Smart Energy Systems for coherent 100% renewable energy and transport solutions.” Applied Energy 145 (2015): 139-154 discloses the development and design of coherent Smart Energy Systems as an integrated part of achieving future 100% renewable energy and transport solutions. The transition from fossil fuels towards the integration of more and more renewable energy requires rethinking and redesigning the energy system both on the generation and consumption side. To enable this, the Smart Energy System must have appropriate infrastructures for the different sectors of the energy system, which are smart electricity grids, smart thermal grids, smart gas grids and other fuel infrastructures. Integration of intermittent renewable energy such as wind and solar is enabled using new sources of flexibility such as electrochemical batteries.

Advanced rechargeable batteries, such as Electric Vehicle (EV) batteries, provide storage capabilities that degrade through continuous charging and discharging over time (battery life cycle), and would be measured and recorded with other data as battery intelligence. Faria, Ricardo, et al. “Primary and secondary use of electric mobility batteries from a life cycle perspective.” Journal of Power Sources 262 (2014): 169-177, discloses with age and cycling, batteries used in EVs will reach a point in which they will no longer be suitable for electric mobility; however, they still can be used in stationary energy storage. This works aims at assessing the lifecycle (LC) environmental impacts associated with the use of a battery in an EV and secondly, at assessing the LC environmental impacts/benefits of using a battery, no longer suitable for electric mobility, for energy storage in a household.

Nazri, Gholam-Abbas, and Gianfranco Pistoia, eds. Lithium batteries: Science and Technology. Springer Science & Business Media, 2008, discloses the significant progress of li-ion batteries mainly due to the numerous innovations in materials, design and safety aspects of the batteries. EVs utilize complex battery structures that comprise hundreds to thousands of individual cells organized in a hierarchy of banks, modules and packs providing the necessary energy and power requirements for the EV, with other potential values in other applications that may last beyond the vehicle's expected lifetime. Maintaining a battery intelligence history throughout its entire battery life cycle will have economic, monetary, and practical impact on its second use, disposal, recycling options and for managing the battery's value as an asset.

Yu, Haijun, et al. “Key technology and application analysis of quick coding for recovery of retired energy vehicle battery.” Renewable and Sustainable Energy Reviews 135 (2021): 110129, discloses the influence of battery type, model, material, battery status, vehicle information and other factors for battery identification, and how new energy vehicle battery failed to achieve efficient and convenient recycling. Considering the requirements of some recently published government documents and the characteristics of electric vehicle battery, an integrated vehicle identification number (VIN) code is proposed. The studied work presenting a standard of combining battery code and tracking code is proposed based on the analysis of the current national standards GB 16735-2019 road vehicle-VIN identification number and GB/T 34,014-2017 code rules for vehicle power battery.

Traditionally, identity systems for battery manufacturers have evolved from efforts to curtail counterfeiting, with cheaper and lower quality batteries creating an unsafe condition for the equipment owner. These efforts are three-fold, first, by providing a unique physical shape for the battery pack to increase the difficulty of producing a counterfeit. Second, by developing an attestation system for the battery using fuses and resistors to create a simple handshake between the equipment and the battery. And finally, the modern approach of using a cryptographical hashing algorithm on a chip embedded with a public key in the battery that could be read and verified by the equipment.

Bai, Yaocai, et al. “Energy and environmental aspects in recycling lithium-ion batteries: Concept of Battery Identity Global Passport.” Materials Today (2020) discloses the emergence and dominance of lithium-ion batteries in expanding markets such as consumer electronics, electric vehicles, and renewable energy storage are driving enormous interests and investments in the battery sector. The studied work highlights the growing demand generating a huge number of spent lithium-ion batteries, thereby urging the development of cost-effective and environmentally sustainable recycling technologies to manage end-of-life batteries. The work identifies the fundamental and technological challenges for recycling of end-of-life batteries, and provides an overview of the current state of battery recycling strategies. Perspectives on the future energy and environmental science are discussed with respect to a new concept introduced as the Battery Identity Global Passport (BIGP). However, the structural complexity of EV batteries requires a more sophisticated system for battery identification, as early advanced battery identification systems such as the BIGP only provide a snapshot of basic information at the time of manufacturing.

The main use of the battery passport is at the point of provisioning to indicate various battery information, which only changes or is updated when the battery is moved from its original application to another one, like how a real passport is stamped when the individual is going from one country to another. While a battery passport may serve to allay the risks associated with counterfeiting and provide some additional information on the source of materials, considering that the EV battery itself represents up to one third of the cost of a vehicle (a sizable asset), and that there are inherent hazards simply because of high-voltage charges held by the battery, the idea of keeping historic information about the battery linked to its identity down to the pack and sub-pack level is ever more important. Beaudet, Alexandre, et al. “Key Challenges and Opportunities for Recycling Electric Vehicle Battery Materials.” Sustainability 12.14 (2020): 5837, discloses key challenges and opportunities for recycling electric vehicle battery materials to facilitate data sharing on the materials' chemistry, origin, state of health of batteries, and chain of custody, which allows stakeholders to identify and track batteries throughout the life cycle, facilitating both repurposing and recycling.

The long-term application of batteries in an EV and beyond requires a different strategy and each auto manufacturer is devising their own systems and methods in coordination with the car's Battery Management System (BMS) provider specific to each EV in organizing the data associated with the EV's make and model. As the ever-increasing number of EVs and in general EVs replacing Internal Combustion Engine (ICE) cars, a general interoperability system is lacking for identity and intelligence on the battery asset.

Hyde, Roderick A., et al. “System and method for predictive control of an energy storage system for a vehicle.” U.S. Pat. No. 9,878,631. 30 Jan. 2018 discloses a system and method for management of an energy storage system for a vehicle. The energy storage system may comprise a battery system for a vehicle such as an electric vehicle or hybrid-electric vehicle. The management system may be configured to use data and information available from data sources over a network or by instrumentation/sensors for vehicle systems. Data and information could be used in a system to manage the configuration and operation of the energy storage system and components, manage/control inventory and use/life-cycle of components, and/or aggregated/analyzed in analytics function for systems and components. Predictive control of the battery system may be implemented through a management system using data sources external to the vehicle.

Chen, Fei, L. I. Shijing, and D. E. N. G. Xiaojia. “Cloud storage-based system and method for electric vehicle battery exchange.” U.S. patent application Ser. No. 16/086,125. discloses a cloud storage-based battery swap system for an electric vehicle, which is intended to solve the problems of the existing electric vehicles, such as inconvenient use of an energy supply system, and excessive individual difference and excessive cost of a battery pack. This invention proposes a battery pack information storage apparatus which is for storing battery pack information of an electric vehicle; a battery pack allocation station for storing battery packs and charging the battery packs; and a battery swap station for replacing a battery pack for the electric vehicle, and communicating with the battery pack information storage apparatus to transmit the battery pack information to the battery pack information storage apparatus.

There is a desire in the field for a solution to address at least some of the issues raised relating to the above identified prior art.

### SUMMARY OF THE INVENTION

Configurable global identity modules (BIM) on EV battery packs would be able to link information from a specific battery module such as the current state of charge (SOC) and state of health (SOH) of the battery, as well as other relevant information not kept by the manufacturer or provided by the BMS. In the current state of the art and as described in the related art above, the battery pack is only identified within the context of the EV. In the event the battery pack or module is removed from the EV the historic data is lost.

The invention is comprised of an identity module (BIM) embedded at the sub-pack level capable of remote or self-sovereign provisioning that can create a globally unique cloud-based identity.

In accordance with an embodiment of the invention, a system for managing event data, and collecting information and battery life intelligence (BLI) in the context of the BIM, which can be transferred directly through a separate module or using the EV's BMS and the communication channel to the cloud.

A Digital Data-Trust Engine (DDTE) is a distributed and decentralized data privacy and security structure for the overall system providing a trust framework for the system whereby stored data lake on the cloud would be queried securely by authorized persons and channels for life cycle events and the relative changes in the battery's SOC, SOH, and other relevant data (BLI).

The system designed is a combined database-blockchain and decentralized cloud framework capable of allowing permissioned entities to program and run their own Machine Learning (ML) and Artificial Intelligence (AI) models based on the quantized data gathered from the cloud-based data lake.

The framework will be auditable and governable by individual national entities while providing visibility into the battery asset to international entities.

Other aspects and features of the invention will become apparent to those ordinarily skilled in the art upon review of the following description of specific embodiments of the invention in conjunction with the accompanying figures.

### BRIEF DESCRIPTION OF THE DRAWINGS

The accompanying drawings illustrate non-limiting example embodiments of the invention.

FIG. 1 depicts the simplified physical architecture of a BIM on a sub-pack in a two-layer battery.

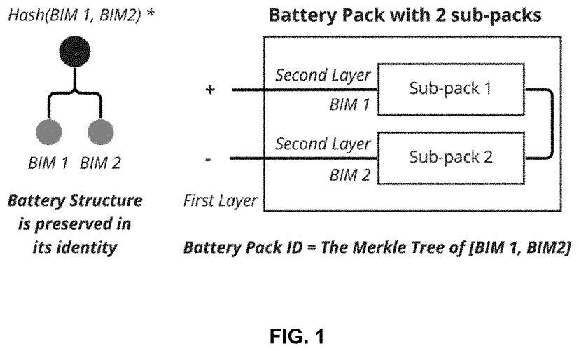

FIG. 2 depicts an overview of the implementation of a multi-layer model, specifically a multi-layer model of battery identity where the hierarchy of the battery cell, module and pack is retained by incorporating the processing unit at specific communication junctures based on the battery's design, makeup, and physical structure.

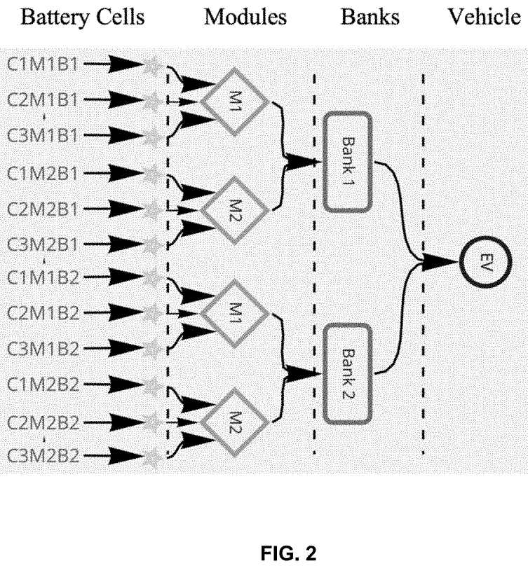

FIG. 3 depicts an electronic implementation of BIM in the secure enclave of the sub-pack processing unit in a Trusted Execution Environment (TEE). The responsibility of the TEE on the sub-pack's chip is to securely hold and manage the BIM.

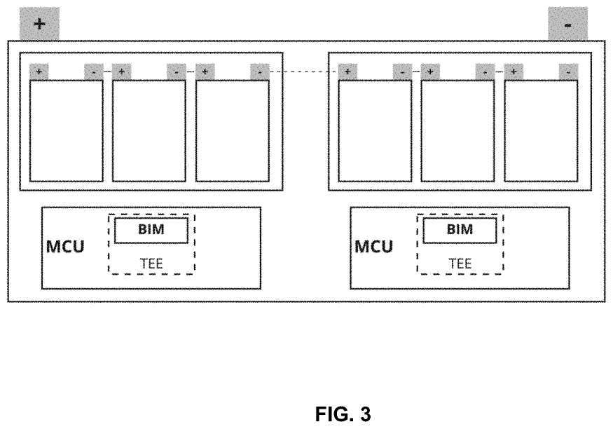

FIG. 4 illustrates the communication within the pack between sub-packs (modules and cells) and the BMS.

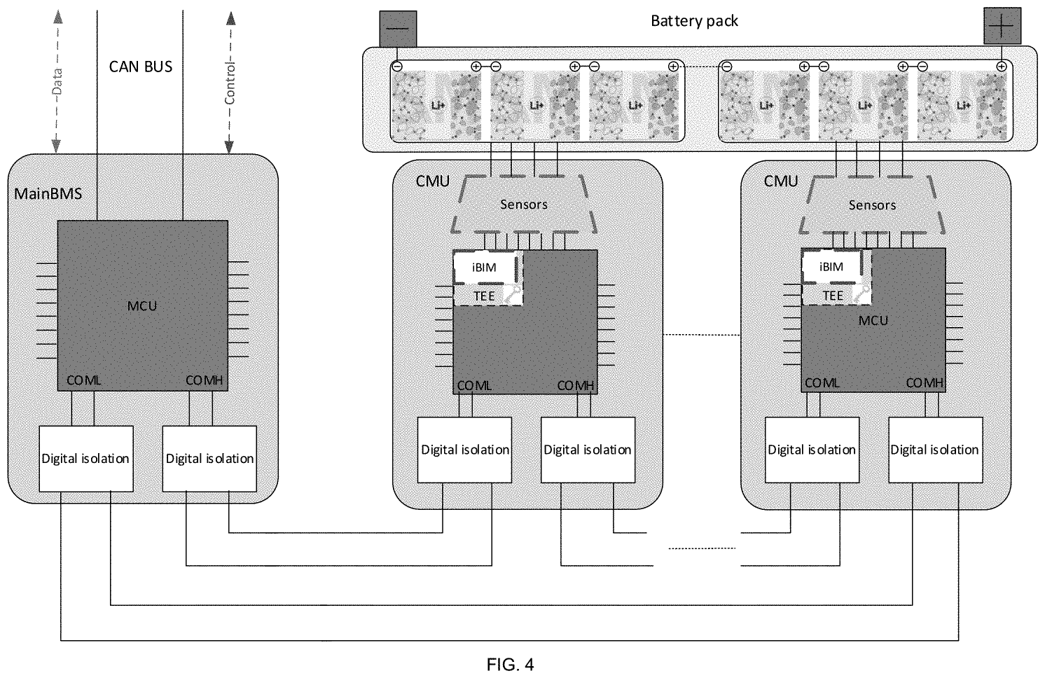

FIG. 5 depicts provisioning and control layer for BIM in the cloud and the path to the cloud data lake storage layer.

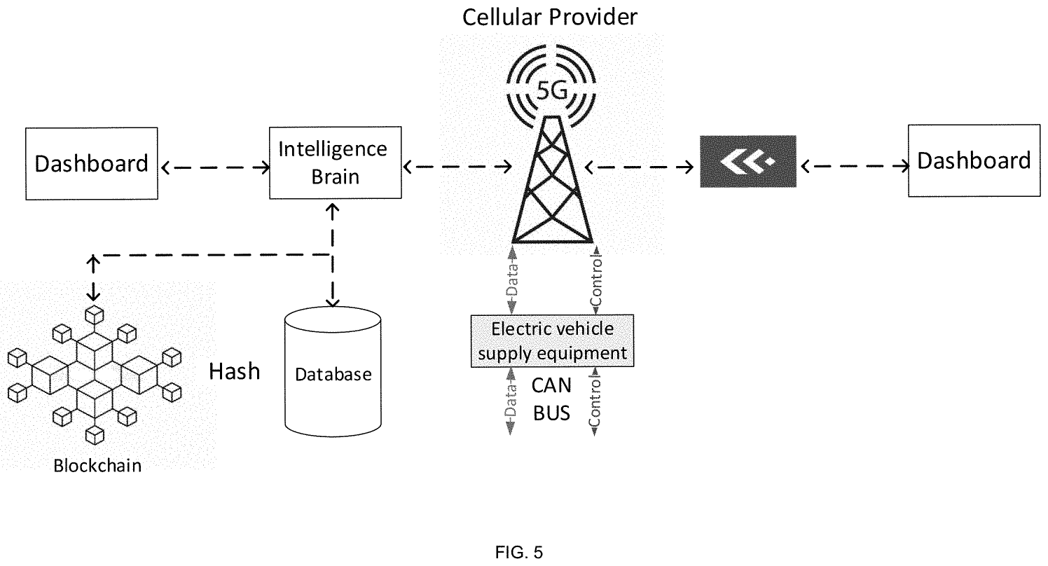

### DETAILED DESCRIPTION

Throughout the following description, specific details are set forth in order to provide a more thorough understanding to persons skilled in the art. However, well known elements may not have been shown or described in detail to avoid unnecessarily obscuring the disclosure. The following description of examples of the technology is not intended to be exhaustive or to limit the system or method to the precise forms of any example embodiment. Accordingly, the description and drawings are to be regarded in an illustrative, rather than a restrictive, sense.

The invention presents a BIM embedded at the sub-pack level capable of remote or self-sovereign provisioning that can create a globally unique cloud-based identity. It utilizes the communications path from the sub-pack level within the battery enclosure to the BMS using wired communications such as Power Line Communication (PLC) as a non-limiting example, and then using cellular communication to send the information to be stored on the cloud data lake. In some embodiments, other means of wireless communication of information may be utilized. The plurality of the sub-packs and their structure is identified by a unique identity and stored at the memory storage system (cloud) layer, tagged within each sub-pack's globally unique identity.

Using said simplified architecture, embodiment of the processing unit on the sub-pack of the two-level architecture is depicted where the sub-pack's processing unit is an ARM designed microchip with a Trusted Execution Environment (TEE), dividing the Real Time Operating System (RTOS) into secure and unsecure operating domains.

The responsibility of the TEE on the sub-pack's chip is to securely hold and manage the BIM. The main function of the chip is to gather information about the cells on the sub-pack and forward the data to the BMS. The only change in this proposed design is to upgrade the processing unit to have a TEE, in which the BIM identity is created. Subsequently, the data forwarded to the BMS will include the identity marker in the data packets forwarded. Moreover, the communication would be bi-directional where the cloud controller may communicate with the processing unit for provisioning of changes in the identity marker based on the significant changes in the battery life cycle.

The cloud control layer is responsible, among other functions, for ensuring and validating the globally unique identity of the BIM. The provisioning system ensures an auditable and immutable quantized data source in the virtualized and cloudified data lake. The process is automated and scalable through blockchain smart contracts.

In a multi-layer model, the hierarchy of the battery cell, module and pack may be retained by incorporating the processing unit at specific communication junctures based on the battery's design, makeup, and physical structure. The responsibility of the processing unit is to extend the data forwarded to the higher layers with data marked by the identity of the lower layer attached as a graph, very much like a Merkle tree, to be deciphered at the cloudified layer. By delegating the function of processing and computing to the cloud layer, the weight of computing at the processing unit's sub-pack level is not altered, as the main addition to the current structure is the placement of the BIM in the TEE.

The main invention being the identity structure in the resulting tree may preserve any physical changes on the layers or packs by the change of hierarchy in the identity layer independent of the data forwarded. Further intelligence would be provided for reuse and reconfigurations recorded at the cloud level with appropriate time stamps indicating the timelines of those changes in the battery's life cycle. The method preserves data in the same hierarchical format as the battery's physical structure as identified by the BIM.

The nature of the proposed BIM is similar to the Subscriber Identity Module (SIM) designs of various forms of software identity used in the cellular wireless industry. Unlike the physical form factor commonly used in cellular phones, the electronic software version, iSIM, is envisioned. The methodology may be the same for an embedded chip version (eSIM). The addition of the eSIM to the battery's sub-pack would not alter the design or architecture of the battery. In an alternate eSIM version, the provisioning and life cycle changes might make access more difficult than an integrated version iSIM. Systems such as ARM's Pelion would allow for the provision of the BIM and the control layer remotely.

A series of Representational State Transfer APIs (RESTful APIs) at the cloud layer are responsible for BIM identity provisioning and changes during the battery life cycle, which are coupled with a provisioned blockchain (such as R3 Corda) and its smart contract flows. Digital Asset Markup Language (DAML) would be used to express smart contract logic, abstracting the access control layer. The blockchain controls authentication, authorization, accounting, and auditing (AAAA) for the accumulated data in the cloud data lake. The BIM and the associated data are separated, similar in fashion to the Control and User Plane Separation (CUPS) used in a 5G network structure.

With respect to the data path to the data lake cloud storage, and the data from the cloud controller to the chip on the battery sub-pack, the proposed invention may include any data structure such as, by way of non-limiting example, a JavaScript Object Notation (JSON) binary object that could be transmitted using wired communication between the sub-pack and the BMS. Assembled communicated JSON data reflect the sub-pack's structure of the physical makeup of the complex battery for further communication and forwarding to the cloud layer. These events could occur at any interval as the situation requires. The data communication events sent to the cloud would initially be the connection to a charger for receiving electricity or for providing the electricity stored in the battery for the use by the electricity grid operator as in Vehicle to Grid (V2G) or for other devices (Vehicle to Everything—V2X).

The cloud storage layer would be a data lake that stores the raw data from the battery along with a blockchain control layer for security, privacy, and authorized access control rules defined and controlled by a smart contract through DAML. This Service Oriented Blockchain (SOB) is responsible for recording the complex physical battery design structure over time with any changes during the battery's life cycle. Parsing the JSON object received would reflect the identity structure changes, if any, and timestamped as it occurs, thereby creating an immutable record of such changes in a digital ledger.

The BIM meets the requirements for interoperability with iSIM. The BIM utilizes the same support structure as iSIM. Chief among these benefits is the security and privacy of the embedded Universal Integrated Circuit Card (eUICC), which is the technology that powers software based iSIMs. Moreover, its extensive use in Internet of Things (IoT) and the automotive industry has proven its usability. The major process change here is the delegation of control from the cellular carrier to the BIM through an intermediate layer of communication and BMS going through wired connection to the sub-pack level.

The reverse wired connection path occurs for data from the sub-pack to the BMS, going through the layers of physical connections communicating sub-pack sensor data and information to the BMS. A snapshot of the device at the collection event may be forwarded onto the vehicle communication module and subsequently meet the RESTful API responsible for further processing and storage at the cloud level.

The RESTful API is triggered in a wireless system through an SDN-NFV function. The EV's wireless communication hardware enables the exchange of data between the system and the car. The system views the battery as a complex structure identified by a cryptographically advanced Merkle tree of the battery, and its sub-level components identified by the BIM. The difference in the state of art today is that every vehicle is viewed as a single entity whereas in this system the complexity of the battery pack is taken into consideration, and an EV is represented as a collection of battery modules and cells each uniquely identified. The information is then expressed by the battery structure and the BIM of each sub-pack. The DDTE hashes the complete bundle and keeps a signature on the blockchain along with a time stamp representing the event. The hash links the control layer in the blockchain to the data layer in the cloud data lake.

The DDTE is the blockchain control layer (AAAA) that validates and verifies the information received or retrieved from the cloud data lake by ensuring Confidentiality, Integrity and Availability (CIA).

Quantization of data is also part of the DDTE in the framework. There are three different types of queries based on time and allowed by the DDTE. The resulting response is a data bundle that would be travelling along with its assigned BIM markers. The first type of query would be the current state or the latest data at the lake. The second type is a closed query of the total data available between two specified dates and times. And finally, an open query stating either the start date and time or the end date and time and requesting whatever data is available while leaving the other parameter undefined. The DDTE would then validate the hash of the hashes of data in the lake and provide the quanta of data for further use.

The access function through the DDTE requires two parameters for the data retrieved. If neither parameter is defined, the current hash associated with the BIM is queried from the database through the blockchain. A consistent structure with four components. Data in JSON format along with code defined in a smart contract detailing the operations that could be performed on the data would be allowed by the DDTE. The second is CIA data verified by the DDTE and the audit path, if needed for example by an entitled body responsible for regulation and compliance. The third is the list of intended recipients of data and a key combination for decrypting the data. And finally, the external Machine Learning (ML) activities that could bring in other relevant data in the context of the BIM.

The relationship between data and the DDTE is attested by cryptographical algorithms by the DDTE and its associated aspects of the CIA. The cellular SDN-NFV further allows geographical or location-based information to be included as necessary.

In some embodiments, the 5G aspect of the SDN-NFV infrastructure for the wireless framework is the foundational base and would be further extended to Citizen Band Radio Services (CBRS) or similarly to WiFi 6 or any other fixed wireless methodology. The components of such a system based on a cloud controller for the system could be divided into three areas. They are termed as South-Bound (SB), North-Bound (NB) and East-West (EW).

South-Bound (SB) defines the path of the cloud controller interaction between the system and the EV. The BIM controller, responsible for provisioning and managing BIMs in the system, is situated as software in the cloud. The system extends to Multi-access Edge Computing (MEC) through a wireless networking connection to provision the profile of the eUICC for identifying the sub-pack. The NB path is the dashboard connection to the controller that is managing the BIM through the cloud controller. The EW connection is the physical connection between the cloud controllers in a wireless network to each other. Effectively, it is a distribution of cloud controllers regionalized through MEC. The BIM provisioning and reconfiguration service as such would interoperate as a cloud service in an SDN-NFV manner, to use 5G CUPS terminology.

In the NB connection to cellular systems, providers are able to provision and control eUICC profiles in a similar manner over the last 5 years, as a non-limiting exemplary time period. The BIM operates on the basis of this same standard aiming to decrease the time to market with as a mature and proven enumeration methodology.

To separate a complex EV battery safely and properly into its subcomponents for reuse or recycling, it requires a methodology and system that can uniquely identify a sub-pack down to its disassembled state, while maintaining a history of its SOC, SOH and other information in the BLI. The machinery depicted here would be a redundant device that reads the BIM to get the current state of battery information. The device depicted is a standalone device, and subsequent models are envisioned that can allow a mobile device, such as a smart phone to achieve the same result.

### Interpretation of Terms

Unless the context clearly requires otherwise, throughout the description and the claims:
“comprise,” “comprising,” and the like are to be construed in an inclusive sense, as opposed to an exclusive or exhaustive sense; that is to say, in the sense of “including, but not limited to”.
“connected,” “coupled,” or any variant thereof, means any connection or coupling, either direct or indirect, between two or more elements; the coupling or connection between the elements can be physical, logical, or a combination thereof.
“herein,” “above,” “below,” and words of similar import, when used to describe this specification shall refer to this specification as a whole and not to any particular portions of this specification.
“or,” in reference to a list of two or more items, covers all of the following interpretations of the word: any of the items in the list, all of the items in the list, and any combination of the items in the list.
the singular forms “a”, “an” and “the” also include the meaning of any appropriate plural forms.
“power source” and “power supply” refer to any source of electrical power in a form that is suitable for operating electronic circuits.
“user”, “subject”, “patient”, “individual”, “subscriber”, “participant” are understood to be used interchangeably in the disclosure and to refer to a bipedal animal, like a human.
“resource” or “resources” are to be understood as any type of physical resource of value including a financial resource such as cash, cryptocurrency, stock, holdings in stocks, bank deposits, holdings in public trade bonds, foreign currency holdings, checks, etc. as well as physical commodities like rare elements or precious elements, for which a financial value may be determined.

Words that indicate directions such as “vertical”, “transverse”, “horizontal”, “upward”, “downward”, “forward”, “backward”, “inward”, “outward”, “vertical”, “transverse”, “left”, “right” , “front”, “back” , “top”, “bottom”, “below”, “above”, “under”, “upper”, “lower” and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

Where a component (e.g. a circuit, module, assembly, device, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of device and method have been described herein for purposes of illustration. These are only examples. The technology provided herein can be applied to device and method other than the examples described above. Many alterations, modifications, additions, omissions and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions and sub-combinations as may reasonably be inferred. The scope of the claims should not be limited by the preferred embodiments set forth in the examples, but should be given the broadest interpretation consistent with the description as a whole.

What is claimed is:

1. A cloud-based identification and digitization system for advanced batteries, the system comprising:
a Battery Identity Module (BIM) for electronic identification of advanced rechargeable batteries , the BIM extending down to the sub-pack, module, and cell levels of the rechargeable batteries;
a Trusted Execution Environment on a chip of the sub-pack to securely hold and manage the BIM, wherein the chip is configured to gather information about the modules and cells of the rechargeable batteries and forward the information gathered to a Battery Management System (BMS);
a Battery Life Intelligence system for recording, storing, and compiling battery event data, and managing battery life information in the context of the BIM;
a communications path from the sub-pack level within an enclosure of the rechargeable battery to the BMS, the communications path is configured for using wired communications and then using cellular communication to transmit the information gathered to be stored on a cloud data lake; and
a cloud control layer for validating a globally unique identity of the BIM, wherein the system provides an auditable and an immutable quantized data source in a virtualized and a cloudified data lake.

2. The system according to claim 1, wherein the information gathered includes an identity marker, and wherein the communications path is bi-directional, wherein the cloud control layer communicates with a processing unit for provisioning and changes in the identity marker based on the significant changes in the rechargeable battery life cycle.

3. The system of claim 1, wherein the Battery Identity Module is configured for use for electric vehicle batteries implemented at the sub-pack, module and cell levels.

4. The system of claim 1, wherein the globally unique identity of the rechargeable battery's physical components (packs, modules, and cells) as standalone digitalized energy asset is configured to enable a secure and transparent scope into the entire battery life cycle, and for all stakeholders across the battery value chain.

5. The system of claim 1, wherein the globally unique identity has a structure, which preserves any physical changes on layers or packs created by a change of hierarchy in the global unique identity layer independent from the information gathered and forwarded.

6. The system of claim 1, the system further comprises an immutable, decentralized, distributed platform employed for retaining BLI and a long-term utilization of the rechargeable battery during the life cycle of the rechargeable battery.

7. A cloud-based identification and digitization method for advanced batteries, the method comprising:
providing a Battery Identity Module (BIM) for electronic identification of advanced rechargeable batteries, the BIM extending down to the sub-pack, module, and cell levels of the rechargeable batteries;
providing a Trusted Execution Environment on a chip of the sub-pack to securely hold and manage the BIM, and using the chip to gather information about the modules and cells and to forward the gathered information to the BMS;
recording, storing, and compiling battery event data, via a Battery Life Intelligence system and managing battery life information in the context of the BIM;
providing a communications path from the sub-pack level within an enclosure of the rechargeable battery to the BMS and configuring the communications path for using wired communications and then using cellular communication to transmit the information gathered to be stored on the cloud data lake; and
providing a cloud control layer for validating a globally unique identity of the BIM, wherein the method provides an auditable and an immutable quantized data source in a virtualized and a cloudified data lake and wherein the method is automated and scalable through blockchain smart contracts.

8. The method of claim 7, further comprising providing a series of Representational State Transfer APIs at the cloud layer for BIM identity provisioning and changes during the battery life cycle, which are coupled with a provisioned blockchain and its smart contract flows.

9. The method of claim 7 further comprising the step of providing a digital data trust engine as a blockchain control layer that validates and verifies information received or retrieved from the cloud data lake by confirming confidentiality, integrity and availability.

10. The method of claim 7 further comprising collecting information about the full battery life cycle including the origin of materials to manufacturing, service life, and recycling.
